(19) United States
(12) Patent Application Publication
(10) Pub. No.: US 2024/0396381 A1
(43) Pub. Date: Nov. 28, 2024

(54) CHOKE ATTENUATION OF INDUCED MOTOR CURRENTS

(71) Applicant: GM GLOBAL TECHNOLOGY OPERATIONS LLC, Detroit, MI (US)

(72) Inventors: William T. Ivan, Shelby Township, MI (US); Mehrdad Teimorzadeh, Troy, MI (US); Rajeev Vyas, Rochester Hills, MI (US); Alireza Fatemi, Canton, MI (US)

(73) Assignee: GM GLOBAL TECHNOLOGY OPERATIONS LLC, Detroit, MI (US)

(21) Appl. No.: 18/323,678

(22) Filed: May 25, 2023

(51) Int. Cl. H02K 1/14; H02K 5/02; H02M 7/00

(52) U.S. Cl. CPC H02K 1/148; H02K 5/02; H02M 7/003

(57) ABSTRACT

An alternating current (AC) choke having a housing extending along a longitudinal axis and at least partially defining a three-phase conductor opening extending along the longitudinal axis. A plurality of core segments is at least partially enclosed in the housing along the longitudinal axis and surround the longitudinal axis.

### INTRODUCTION

The subject disclosure relates to an alternating current (AC) choke with a multi-phase AC bus used to power a multi-phase AC machine.

Multi-phase AC machines are known to exhibit substantial induced currents within the machine structures. Induced currents within the machine structures may be undesirable.

Therefore, it is desirable to reduce or eliminate induced currents through the machine bearings.

### SUMMARY

Disclosed herein is an AC choke. The AC choke includes a housing extending along a

longitudinal axis and at least partially defining a three-phase conductor opening extending along the longitudinal axis. A plurality of core segments is at least partially enclosed in the housing along the longitudinal axis and surround the longitudinal axis.

Another aspect of the disclosure may be where a sum of an axial length of the plurality of core segments is at least 5 times greater than an average thickness of the plurality of core segments in a radial direction relative to the longitudinal axis.

Another aspect of the disclosure may be where a sum of an axial length of the plurality of core segments is between 15 and 17 times greater than an average thickness of the plurality of core segments in a radial direction relative to the longitudinal axis.

Another aspect of the disclosure may be where each of the plurality of core segments form a continuous loop surrounding the longitudinal axis.

Another aspect of the disclosure may be where adjacent core segments of the plurality of core segments are in abutting contact.

Another aspect of the disclosure may be where a portion of the housing separates adjacent core segments of the plurality of core segments.

Another aspect of the disclosure may be where the housing is comprised of a thermal composite material.

Another aspect of the disclosure may be where the housing is a single unitary component and the plurality of core segments are positioned along the longitudinal axis in a non-overlapping configuration.

Another aspect of the disclosure may be where each of the plurality of core segments are symmetrical about at least one plane extending through to the longitudinal axis.

Another aspect of the disclosure may be where a cross-sectional area of each of the plurality of core segments is equal.

Another aspect of the disclosure may be where a cross-sectional area between at least one pair of adjacent core segments of the plurality of core segments varies.

Another aspect of the disclosure may be where the plurality of core segments is comprised of a nano-crystal material.

Another aspect of the disclosure may be where the plurality of core segments is comprised of ferrous-based material.

Disclosed herein is an alternating current (AC) multiphase machine system. The system includes an AC multiphase machine including a rotor and a stator having multi-phase AC stator windings and a power inverter producing a multi-phase AC voltage. An AC bus is coupled between the power inverter and the multi-phase AC stator windings. At least one AC choke surrounds the AC bus. The AC choke includes a housing extending along a longitudinal axis and at least partially defining a three-phase conductor opening extending along the longitudinal axis. A plurality of core segments are at least partially enclosed in the housing along the longitudinal axis and surround the longitudinal axis.

Disclosed here is an electrified powertrain. The electrified powertrain includes a battery pack and a traction power inverter module (“TPIM”) connected to the battery pack to change a direct current (“DC”) voltage from the battery pack to a multi-phase alternating current (“AC”) voltage. A rotary electric machine is energized by the multi-phase AC voltage from the TPIM over a multi-phase AC bus. The rotary electric machine includes a stator having multi-phase AC stator windings, a rotor, and a rotor shaft connected to and surrounded by the rotor for rotating about an axis of rotation in conjunction with the rotor when the rotary electric machine is energized. At least one AC choke surrounds the multi-phase AC bus. The AC choke includes a housing extending along a longitudinal axis and at least partially defining a multi-phase AC bus opening extending along the longitudinal axis. A plurality of core segments is at least partially enclosed in the housing along the longitudinal axis and surround the longitudinal axis. A sum of an axial length for the plurality of core segments is at least five times greater than an average thickness of the plurality of core segments in a radial direction relative to the longitudinal axis.

### BRIEF DESCRIPTION OF THE DRAWINGS

FIG. 1 illustrates an electric propulsion system on a vehicle, in accordance with one or more embodiments.

FIGS. 2A-2C illustrate models of a motor of the electric propulsion system, in accordance with one or more embodiments.

FIG. 3 illustrates an electric drive unit of the electric propulsion system, in accordance with one or more embodiments.

FIGS. 4A illustrates an AC choke and bus bars, in accordance with one or more embodiments.

FIG. 4B illustrates a cross-sectional view of the AC choke and bus bars taken along line 4B-4B of FIG. 4A.

FIG. 4C illustrates a cross-sectional view of the AC choke taken along line 4C-4C of FIG. 4A.

FIG. 4D illustrates a cross-sectional view of the AC choke taken along line 4D-4D of FIG. 4A.

FIG. 5 illustrates an AC choke according to another embodiment.

FIG. 6 illustrates an AC choke according to yet another embodiment.

FIG. 7 illustrates an AC choke according to a further embodiment.

The present disclosure may be modified or embodied in alternative forms, with representative embodiments shown in the drawings and described in detail below. The present disclosure is not limited to the disclosed embodiments. Rather, the present disclosure is intended to cover alternatives falling within the scope of the disclosure as defined by the appended claims.

### DETAILED DESCRIPTION

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. The following description is merely exemplary in nature and is not intended to limit the present disclosure, its application or uses. Throughout the drawings, corresponding reference numerals indicate like or corresponding parts and features.

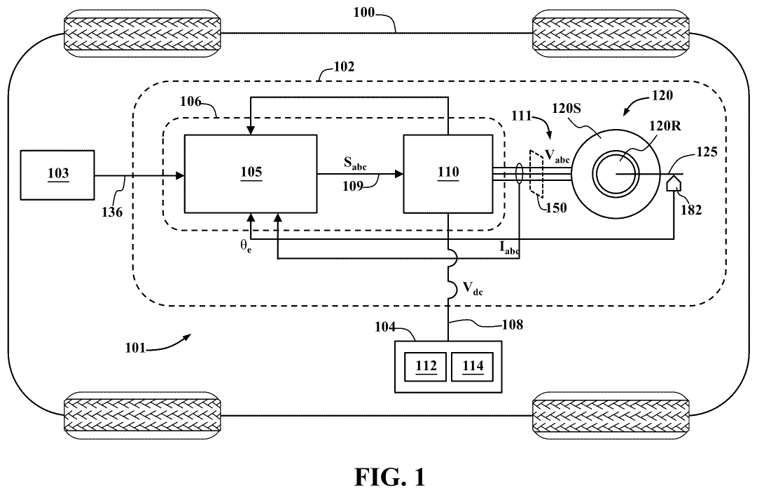

FIG. 1 schematically illustrates an embodiment of an electric propulsion system 101 on a vehicle 100. Vehicle and vehicular are understood to refer to any means of transportation including non-limiting examples of motorcycles, cars, trucks, buses, excavation, earth moving, construction and farming equipment, railed vehicles like trains and trams, and watercraft like ships and boats. The electric propulsion system 101 may include various control components, electrical systems and electro-mechanical systems including, for example, a rechargeable energy storage system (RESS) 104 and an electric drive unit (EDU) 102. The electric propulsion system 101 may be employed on a powertrain system to generate propulsion torque as a replacement for, or in conjunction with, an internal combustion engine in various electric vehicle (EV) applications and hybrid electric vehicle (HEV) applications, respectively.

The EDU 102 may be of varying complexity, componentry and integration. An exemplary highly integrated EDU 102 may include, for example, a rotary electric machine such as an alternating current (AC) motor (motor) 120 and a traction power inverter module (TPIM) 106 including a motor controller 105 and a power inverter 110. The motor 120 may include a stator 120S and a rotor 120R coupled to a motor output shaft 125 and position sensor 182, for example a variable reluctance resolver or an encoder. The position sensor 182 may signally connect directly to the motor controller 105 and is employed to monitor angular position of the rotor (θₑ) of the motor 120. The angular position of the rotor (θₑ) of the motor 120 is employed by the motor controller 105 to control operation of the power inverter 110 that controls the motor 120.

The motor output shaft 125 may transfer torque between the motor 120 and driveline components (not illustrated), some of which may be integrated within the EDU 102, for example in a gearbox including reduction and differential gear sets and one or more axle outputs. The gearbox may simply include reduction gearing and a prop shaft output for coupling to a differential gear set. One or more axles may couple to the gear box directly or through final drive or differential gear sets if separate therefrom. Axle(s) may couple to a vehicle wheel(s) for transferring tractive force between a wheel and pavement. One having ordinary skill in the art will recognize alternative arrangements for driveline components. Propulsion torque requests or commands 136 (T_{cmd}) may be provided by a vehicle controller 103 to the motor controller 105.

Any controller may include one or more control modules. As used herein, control module, module, control, controller, control unit, electronic control unit, processor and similar terms mean any one or various combinations of one or more of Application Specific Integrated Circuit(s) (ASIC), electronic circuit(s), central processing unit(s) (microprocessor(s)) and associated memory and storage (read only memory (ROM), random access memory (RAM), electrically programmable read only memory (EPROM), hard drive, etc.) or microcontrollers executing one or more software or firmware programs or routines, combinational logic circuit(s), input/output circuitry and devices (I/O) and appropriate signal conditioning and buffer circuitry, high speed clock, analog to digital (A/D) and digital to analog (D/A) circuitry and other components to provide the described functionality. A control module may include a variety of communication interfaces including point-to-point or discrete lines and wired or wireless interfaces to networks including wide and local area networks, and in-plant and service-related networks including for over the air (OTA) software updates. Functions of a control module as set forth in this disclosure may be performed in a distributed control architecture among several networked control modules. Software, firmware, programs, instructions, routines, code, algorithms, and similar terms mean any controller executable instruction sets including calibrations, data structures, and look-up tables. A control module may have a set of control routines executed to provide described functions. Routines are executed, such as by a central processing unit, and are operable to monitor inputs from sensing devices and other networked control modules and execute control and diagnostic routines to control operation of actuators. Routines may be executed at regular intervals during ongoing engine and vehicle operation. Alternatively, routines may be executed in response to occurrence of an event, software calls, or on demand via user interface inputs or requests.

The RESS 104 may, in one embodiment, include one or more electro-chemical battery packs 112, for example high capacity, high voltage (HV) rechargeable lithium-ion battery packs for providing power to the vehicle via an HV direct current (DC) bus 108. The RESS 104 may also include a battery manager module 114. The RESS 104 may include one or more battery packs 112 constructed from a plurality of battery pack modules allowing for flexibility in configurations and adaptation to application requirements. Battery packs may include a plurality of battery pack modules constructed from a plurality of cells allowing for flexibility in configurations and adaptation to application requirements. Battery pack modules may include a plurality of cells allowing for flexibility in configurations and adaptation to application requirements. For example, in vehicular uses, the RESS 104 may be modular to the extent that the number of battery pack modules may be varied to accommodate a desired energy density or range objective of a particular vehicle platform, intended use, or cost target. Battery packs and battery pack modules may be variously and selectively configured in accordance with desired propulsion architecture and charging functions. It is understood that the RESS 104 may be reconfigurable at any level of integration including battery pack, battery module and cell.

The motor 120 may be a multi-phase AC motor receiving multi-phase AC power over a multi-phase motor control power bus (AC bus) 111 which is coupled to the power inverter 110. In one embodiment, the motor 120 is a three-phase motor and the power inverter 110 is a three-phase inverter. The power inverter 110 may include a plurality of solid-state switches in a solid-state switching section. The power inverter 110 couples to DC power over the HV DC bus 108 (DC input voltage (V_{dc})) from the RESS 104, for example at 400 or 800 volts. The motor controller 105 is coupled to the power inverter 110 for control thereof. The power inverter 110 electrically connects to stator phase windings of a three-phase stator winding of the motor 120 via the AC bus 111, with electric current (I_{abc}) monitored on two or three phases thereof. The power inverter 110 may be configured with suitable control circuits including paired power transistors (e.g., IGBTs) for transforming high-voltage DC voltage on the HV DC bus 108 to high-voltage three-phase AC voltage (V_{abc}) on the AC bus 111 and transforming high-voltage three-phase AC voltage (V_{abc}) on the AC bus 111 to high-voltage DC voltage on the HV DC bus 108. The power inverter 110 may employ any suitable pulse width modulation (PWM) control, for example sinusoidal pulse width modulation (SPWM) or space vector pulse width modulation (SVPWM), to generate switching vector signals (S_{abc}) 109 to convert stored DC electric power originating in the battery pack 112 of the RESS 104 to AC electric power to drive the motor 120 to generate torque. Similarly, the power inverter 110 may convert mechanical power transferred to the motor 120 to DC electric power to generate electric energy that is storable in the battery pack 112 of the RESS 104, including as part of a regenerative braking control strategy. The power inverter 110 may be configured to receive the switching vector signals (S_{abc}) 109 from motor controller 105 and control inverter states to provide the motor drive and regeneration functionality. Switching vector signals (S_{abc}) 109 may also be referred to herein as conduction commands.

Control of the power inverter 110 may include high frequency switching of the solid-state switches (with redundancy) in accordance with the PWM control. A number of design and application considerations and limitations determine inverter switching frequency and PWM control. Inverter controls for AC motor applications may include fixed switching frequencies, for example switching frequencies around 10-30 kHz and PWM controls that minimize switching losses of the IGBTs or other power switches of the power inverter 110.

The disclosed improvements relate to a multi-phase AC motor 120, and may be realized in HEV and EV embodiments of the vehicle 100 without limitation, as well as in non-vehicular applications such as power plants, hoists, mobile platforms, commercial, industrial, home appliances, and robots, etc. The motor 120 may, for example, be an interior permanent magnet (IPM) machine, a permanent magnet synchronous reluctance (PMSR) machine, a synchronous reluctance (SR) machine, an induction machine, or any AC machine including a multi-phase AC stator 120S. The motor 120 may also be a generator.

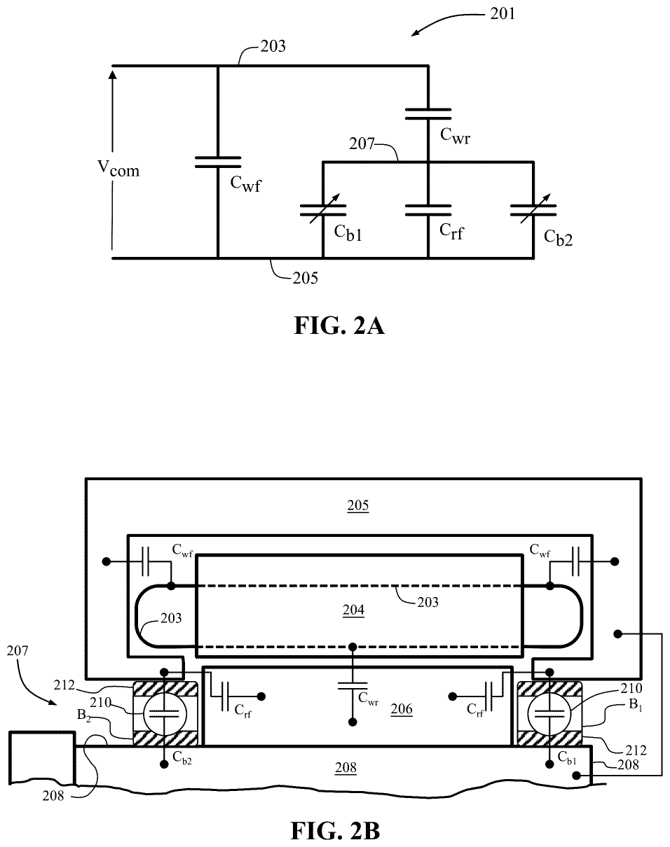

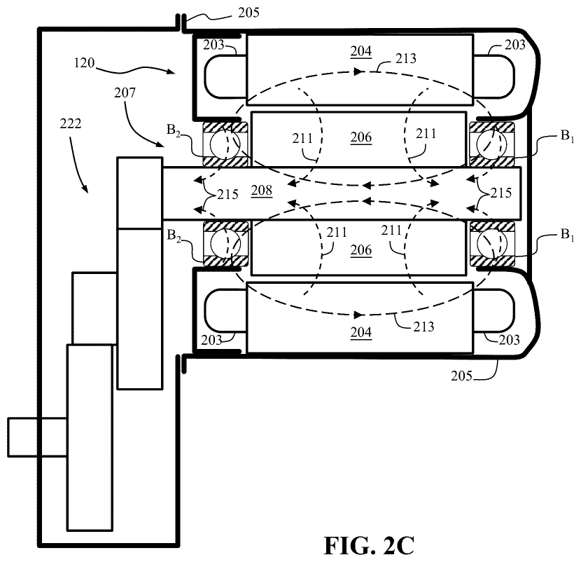

The power inverter 110 operates by synthesizing multi-phase AC voltages which are applied to corresponding phase windings of the multi-phase stator 120S of the motor 120 over the AC bus 111. In addition to the fundamental voltages output onto the AC bus 111, there may be parasitic excitations as a result of non-ideal waveforms. In a balanced three phase system, for example, the three fundamental AC voltages may be substantially sinusoidal and separated by 120 degrees. The summation of the three phase voltages would be equal to zero in an ideal system. However, the power inverter 110 operates by high frequency switching of a DC voltage to synthesize sinusoidal voltages over time. Instantaneous voltages on the AC bus 111 and at the stator phase windings may appear as square waveforms whose summations may not equal zero, thus resulting in high frequency excitations within the motor 120 manifesting in common mode voltages on the stator phase windings. A simplified model of the motor 120 is illustrated in FIGS. 2A, 2B and 2C and additional reference is made to those figures. FIGS. 2A and 2B model an impedance network 201 including a plurality of inherent machine parasitic capacitances “C” among major components and excitation voltages V_{com}. The impedance network 201 may include a winding to frame capacitance C_{wf} from the stator windings 203 in the stator core 204 to the motor frame 205, a winding to rotor capacitance C_{wr} from the stator windings 203 in the stator core 204 to the rotor core 206 and rotor shaft 208 of the rotor 207, a rotor to frame capacitance C_{rf} from the rotor core 206 and rotor shaft 208 of the rotor 207 to the motor frame 205, and bearing impedances C_{b1} and C_{b2} from the rotor core 206 and rotor shaft 208 of the rotor 207 to the motor frame 205 through the bearing B1 and B2, respectively. This impedance network 201 may be excited by the common mode voltages (V_{com}) appearing on the AC bus 111 due to the power inverter 110 operation. The FIGS. 2A and 2B correspond to motor 120 having a pair of bearings B₁ and B₂ though additional bearings may be found in other embodiments. Bearings may include rolling elements 210 and race elements 212.

Various induced currents may be present in the power inverter 110 driven AC motor 120 and are illustrated by the FIG. 2C model of the motor 120. FIG. 2C additionally schematically illustrates an integrated gearset 222. Traditional capacitive currents 211 through the motor 120 may include low amplitude displacement currents through the bearing impedances C_{b1} and C_{b2} due to the voltage appearing on the rotor core 206 and rotor shaft 208 of the rotor 207 (between C_{wr} and C_{rf} in FIG. 2A). Ground currents 213 may flow between the stator windings 203 and motor frame 205 creating a circumferential flux through the motor 120 that induces a voltage across the rotor shaft 208 and results in circulating currents 213 flowing through the bearing impedances C_{b1} and C_{b2}. As illustrated in FIG. 2C, the circulating currents may flow through the bearing B₁ and B₂ in opposite directions. Rotor ground currents 215 may flow through the bearing impedances C_{b1} and C_{b2} as stray currents if the impedance of the rotor 207 back to the inverter frame is lower than the stator core 204 back to the inverter frame. Such rotor ground currents 215 may not be as significant in systems with short AC bus 111 cable runs, and frame integrated inverters. Electrical discharge machining (EDM) currents through the bearing B₁ and B₂ differ from the capacitive displacement currents as EDM currents are partial discharge currents within and through the bearings which may occur due to changes in the bearing impedance. Operating factors such as bearing load, speed and temperature may affect changes in the bearing impedance. Also, design factors such as sealed versus hydrodynamic effects of open, oil lubricated bearings may affect changes in the bearing impedance. Transient factors may also affect changes in the bearing impedance and may include rapid load increases, debris and vibration which may cause closing of the rolling element to race gap. Reductions in the bearing impedance may result in effective shorting of the bearings and undesirable discharge of the rotor voltage as EDM currents.

For the rotor ground currents 215 and circulating currents 213, the winding to frame capacitance C_{wf} from the stator windings 203 in the stator core 204 to the motor frame 205 may be a major factor. Common mode currents, and hence the induced circulating currents 213, may be attenuated through the introduction of a filter in the form of an AC choke 150 operative upon the AC bus 111 as shown in FIG. 1. All phase conductors of the AC bus 111 are coupled to the AC choke 150 and hence the AC choke is effective upon the common mode currents. The addition of the AC choke 150 to the AC bus 111 may increase the impedance of the common mode path at select frequencies thereby attenuating the common mode currents and the downstream induced circulating currents.

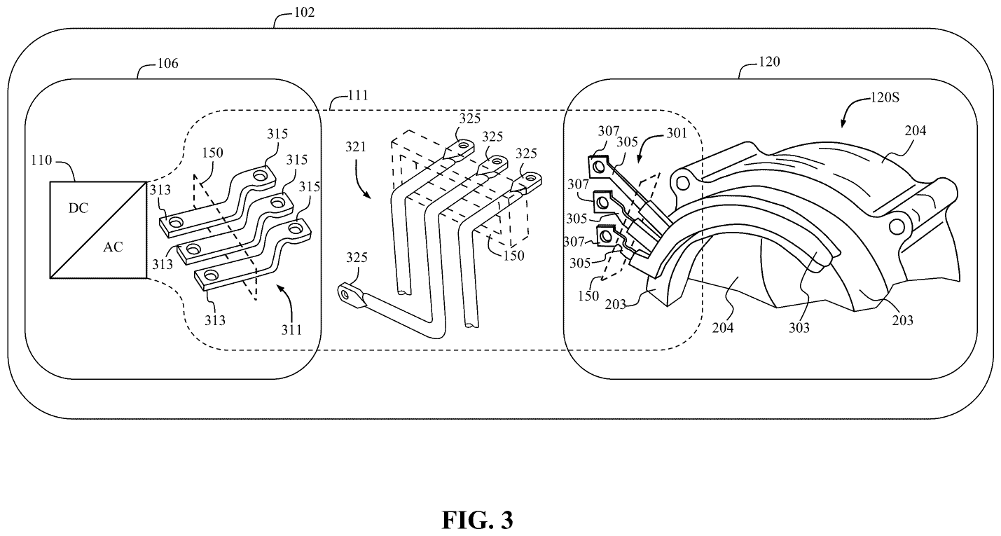

FIG. 3 illustrates the EDU 102 of FIG. 1 including alternate placement embodiments of the AC choke 150 upon the AC bus 111. The AC bus 111 runs between the TPIM 106 and the motor 120. The AC bus 111 provides conductive coupling of the multi-phase outputs of the power inverter 110 to the phase terminals 301 of the stator windings 203. The AC bus 111 may include AC bus features of the TPIM 106, AC bus features of the motor 120 and conductors connecting the AC bus features of the TPIM 106 and the AC bus features of the motor 120. In the three-phase motor 120 there are three-phase terminals 301, each of which includes a respective arcuately shaped stator bus bar 303 connected to respective phases of the stator windings 203 in the stator core 204. The stator bus bars 303 may include phase leads 305 which terminate at connecting pads 307.

In the three phase TPIM 106 the power inverter 110 has three phase outputs (not illustrated) which may be coincident with a solid-state switching section of the power inverter 110. The phase outputs of the power inverter 110 are conductively coupled to one end of three bus bars 311 at respective connecting pads 313. The other end of the three bus bars 311 includes connecting pads 315 which may terminate at TPIM output terminals (not illustrated). In one embodiment, the three bus bars 311 may terminate at an intermediate point within the TPIM and connect to a second set of bus bars which terminate at the TPIM output terminals (not illustrated). The bus bars 311 may be formed from flat copper stock with a generally rectangular cross section and conduct the phase currents from the solid-state switching section of the power inverter 110 to TPIM output terminals (not illustrated). The bus bars 311 may be arranged in spaced adjacency side by side or in a stacked arrangement, in a single plane or multiple planes, oriented horizontally or vertically, or in any combination thereof for all or portions of the bus bars 311.

The AC bus 111 may include AC rods 321 such as those illustrated in FIG. 3. Rods may have any suitable cross section and are illustrated in FIG. 3 with a round cross section with ends having flattened connecting pads 325 at either end. One end of the AC rods 321 may be connected to connecting pads 315 of the bus bars 311. The other end of the AC rods 321 may be connected to the connecting pads 307 of the stator bus bars 303 at the phase terminals 301 of the of the stator windings 203. Connections between bus bars 311 and the AC rods 321 and between the AC rods 321 and the phase terminals 301 may be any suitable connection such as bolt compression, clamping, soldering, welding, or other metal joining, etc. Flexible conductors such as stranded or solid core cables may be used in place of or in addition to bus bars 311 or AC rods 321. As used herein, bus bars are understood to refer to AC bus 111 conductors associated with the power inverter 110 of the TPIM 106. As used herein, phase terminals 301 are understood to refer to AC bus 111 conductors associated with the stator windings 203 in the stator core 204 of the stator 120S of the motor 120. As used herein, AC rods 321 are understood to refer to conductors coupling between the bus bars 311 and the phase terminals 301. The AC choke 150 in FIG. 3 is illustrated in alternative placements surrounding the AC bus 111. Advantageously, the AC choke 150 being passive and independent of galvanic coupling for operation or control, affords flexibility in placement. Therefore, the AC choke 150 may be placed around the bus bars 311, around the AC rods 321 or around the phase terminals 301. In an embodiment, a single AC choke 150 may be placed in any suitable location surrounding the AC bus 111. In an embodiment, two or more AC chokes 150 may be placed at multiple locations surrounding the AC bus 111.

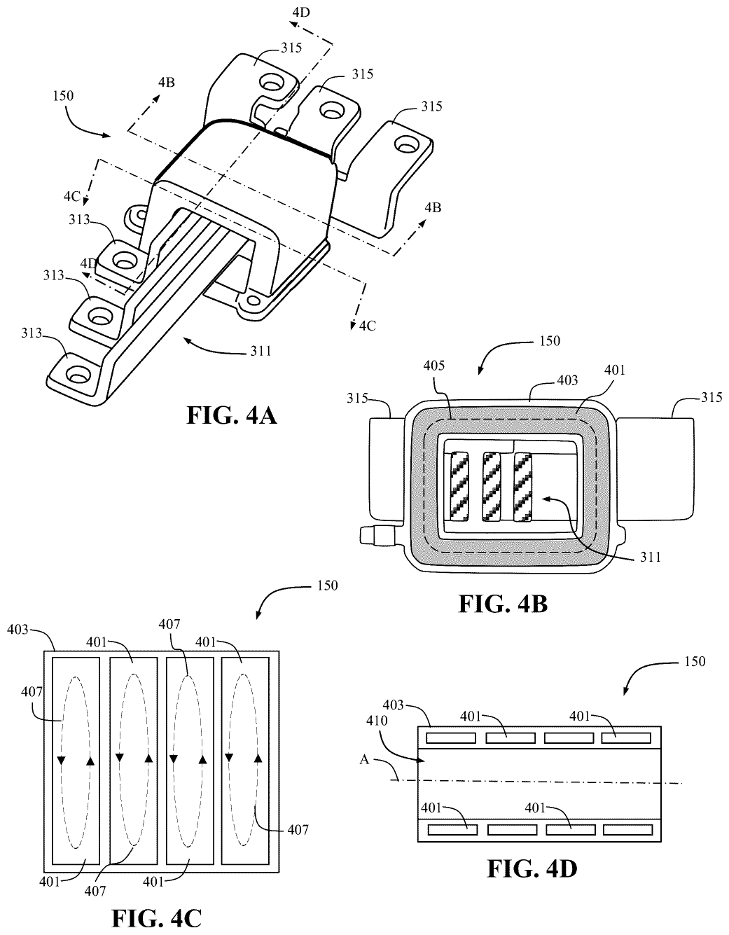

FIGS. 4A-4D illustrate the AC choke 150 surrounding bus bars 311 between connecting pads 313 and connecting pads 315. However, the AC choke 150 can be used to surround any set of unshielded three-phase conductors. The AC choke 150 surrounds a part of the bus bars 311 that are stacked in spaced adjacency thus allowing for a compact AC choke 150. FIG. 4B illustrates the AC choke 150 and the bus bars 311 in section taken along the line 4B-4B in FIG. 4A. The AC choke 150 includes the housing 403 and a plurality of core segments 401 (FIG. 4C) with a single core segment 401 shaded in FIG. 4B. The housing 403 may be an over molded plastic, thermal composite, polyurethane or similar insulator or dielectric material suitable for electrical isolation and mounting structure purposes. Sections through the bus bars are illustrated in crosshatch. The cores 401 of the AC choke 150 have a mean length for the flux path 405 shown by the closed dashed line. One feature of the core segments 401 positioned in the housing 403 is improved heat dissipation. Also, the core segments 401 reduce the formation of eddy currents 407 with minimal impact on packaging for the AC choke 150.

The inductance of the AC choke 150 is the mechanism by which the AC choke 150 attenuates the undesirable common mode currents and may be defined by the material (permeability vs. frequency), its saturation limit and geometry (i.e., section through one of the cores 401, mean length of the flux path 405 through one of the cores 401). The size of the core 401 affects the saturation limit of the AC choke 150 which when reached drops the inductance significantly thus negatively affecting the effectiveness in suppressing the common mode currents. Core 401 materials are generally characterized by permeability vs. frequency and a design objective for the AC choke 150 may be to have sufficient permeability at high frequency to reduce bearing currents (˜500 kHz-3 MHZ) and to avoid saturation at the low switching frequencies from the inverter (ranging ˜1-30 kHz). Exemplary core 401 materials and construction may include ferrites or ferromagnetic powder and binders. In an embodiment, each of the cores 401 may be constructed from wound ribbons (e.g., iron-based nanocrystalline alloy ribbons) to achieve permeability and high saturation limits over a wide frequency range. In an embodiment, a ferrite core may be formed from a powder metal (sintered or molded with binder) and may be a single piece or multiple pieces.

In the illustrated embodiment, the housing 403 extends along a longitudinal axis A (FIG. 4D) to define a three-phase conductor opening 410 and the core segments 401 are positioned along the longitudinal axis A in a non-overlapping configuration. Each of the core segments 401 form a continuous loop surrounding the longitudinal axis of the AC choke 150 (FIG. 4B). However, in an embodiment, the core segments 401 could have discontinuities in the circumferential direction. A cross-sectional profile of the AC choke 150 is symmetrical about both a central vertical plane and a central horizontal plane relative to the orientation shown in FIG. 4B.

As shown in FIGS. 4C and 4D, a portion of the housing 403 separates adjacent core segments 401 from each other and the housing 403 is a single unitary component. As shown in the illustrated embodiment of FIG. 4D, a cross-sectional area of each of the plurality of core segments 401 is equal and the core segments 401 are positioned a common radial distance from the longitudinal axis A.

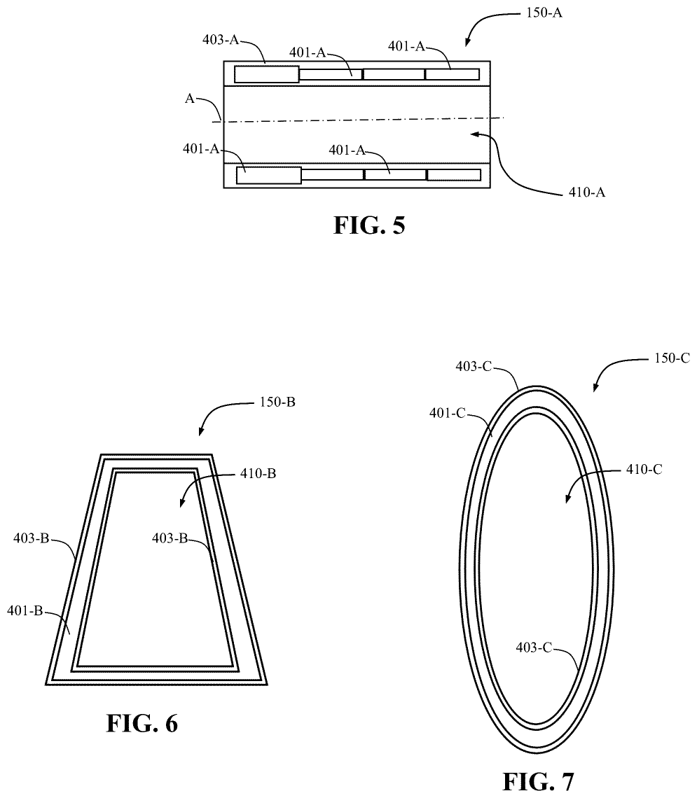

In one embodiment, and a sum of an axial length for the plurality of core segments 401 is at least 5 times greater than an average thickness of the plurality of core segments 401 in a radial direction relative to the longitudinal axis A. In an embodiment, the sum of the axial length for the core segments 401 is at least 10 times greater than an average thickness of the core segments 401 in a radial direction relative to the longitudinal axis. In a further embodiment, the sum of the axial length relative to the longitudinal axis A of the core segments is between 15 and 17 times greater than the average thickness of the core segments 401. Furthermore, adjacent core segments 401 can be in abutting contact with each other and a cross-sectional area between at least one pair of adjacent core segments 401 can vary as shown in FIG. 5.

FIG. 6 illustrates an embodiment of an AC choke 150-B. The AC choke 150-B is similar to the AC choke 150 except where described below or shown in the FIGS. The AC choke 150-B includes a trapezoidal cross-section profile with core segments 401-B enclosed by a housing 403-B. The AC choke 150-B is symmetrical about a central vertical plane. The housing 403-B and the core segments 401-B at least partially define a three-phase conductor opening 410-B extending through a central region of the AC choke 150-B.

FIG. 7 illustrates an embodiment of an AC choke 150-C. The AC choke 150-C is similar to the AC choke 150 except where described below or shown in the FIGS. The AC choke 150-C includes an elliptical cross-section profile with core segments 401-C enclosed by a housing 403-C. The AC choke 150-C is symmetrical about a central vertical plane and a central horizontal plane. The housing 403-C and the core segments 401-C at least partially define a three-phase conductor opening 410-C extending through a central region of the AC choke 150-C.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. An AC choke comprising:
a housing extending along a longitudinal axis and at least partially defining a three-phase conductor opening extending along the longitudinal axis; and
a plurality of core segments with each of the plurality of core segments at least partially enclosed in the housing and surrounding the longitudinal axis, wherein the plurality of core segments is positioned axially along the longitudinal axis.

2. The AC choke of claim 1, wherein a sum of an axial length of the plurality of core segments is at least 5 times greater than an average thickness of the plurality of core segments in a radial direction relative to the longitudinal axis.

3. The AC choke of claim 1, wherein a sum of an axial length of the plurality of core segments is between 15 and 17 times greater than an average thickness of the plurality of core segments in a radial direction relative to the longitudinal axis.

4. The AC choke of claim 1, wherein each of the plurality of core segments form a continuous loop surrounding the longitudinal axis.

5. The AC choke of claim 1, wherein adjacent core segments of the plurality of core segments are in abutting contact.

6. The AC choke of claim 1, wherein a portion of the housing separates adjacent core segments of the plurality of core segments.

7. The AC choke of claim 4, wherein the housing is comprised of a thermal composite material.

8. The AC choke of claim 4, wherein the housing is a single unitary component and the plurality of core segments are positioned along the longitudinal axis in a non-overlapping configuration.

9. The AC choke of claim 1, wherein each of the plurality of core segments are symmetrical about at least one plane extending through to the longitudinal axis.

10. The AC choke of claim 1, wherein a cross-sectional area of each of the plurality of core segments is equal.

11. The AC choke of claim 1, wherein a cross-sectional area between at least one pair of adjacent core segments of the plurality of core segments varies.

12. The AC choke of claim 1, wherein the plurality of core segments is comprised of a nano-crystal material.

13. The AC choke of claim 1, wherein the plurality of core segments is comprised of ferrous-based material.

14. An alternating current (AC) multiphase machine system comprising:
an AC multiphase machine including a rotor and a stator having multi-phase AC stator windings;
a power inverter producing a multi-phase AC voltage;
an AC bus coupled between the power inverter and the multi-phase AC stator windings; and
at least one AC choke surrounding the AC bus, the AC choke including:
a housing extending along a longitudinal axis and defining a multi-phase bus opening; and
a plurality of core segments with each of the plurality of core segments at least partially enclosed in the housing and surrounding the multi-phase AC bus, wherein the plurality of core segments is positioned axially along the longitudinal axis.

15. The AC multiphase machine system of claim 14, wherein a portion of the AC bus surrounded by the at least one AC choke is unshielded and the at least one AC choke includes a plurality of AC chokes.

16. The AC multiphase machine system of claim 14, wherein a sum of an axial length of the plurality of core segments is at least 5 times greater than an average thickness of the plurality of core segments in a radial direction relative to the longitudinal axis.

17. The AC multiphase machine system of claim 14, wherein a sum of an axial length of the plurality of core segments is between 15 and 17 times greater than an average thickness of the plurality of core segments in a radial direction relative to the longitudinal axis.

18. The AC multiphase machine of claim 14, wherein adjacent core segments of the plurality of core segments are in abutting contact.

19. The AC multiphase machine of claim 14, wherein a portion of the housing separates adjacent core segments of the plurality of core segments.

20. An electrified powertrain, comprising:
a battery pack;
a traction power inverter module (“TPIM”) connected to the battery pack, and configured to change a direct current (“DC”) voltage from the battery pack to a multi-phase alternating current (“AC”) voltage;
a rotary electric machine energized by the multi-phase AC voltage from the TPIM over a multi-phase AC bus, and comprising:
a stator having multi-phase AC stator windings;
a rotor;
a rotor shaft connected to and surrounded by the rotor, and configured to rotate about an axis of rotation in conjunction with the rotor when the rotary electric machine is energized; and
an AC choke surrounding the multi-phase AC bus, the AC choke including:
a housing extending along a longitudinal axis and defining a multi-phase AC bus opening; and
a plurality of core segments with each of the plurality of core segments at least partially enclosed in the housing and surrounding the multi-phase AC bus, wherein the plurality of core segments is positioned axially along the longitudinal axis and a sum of an axial length for the plurality of core segments is at least 5 times greater than an average thickness of the plurality of core segments in a radial direction relative to the longitudinal axis.
